(19) United States
(12) Patent Application Publication
(10) Pub. No.: US 2006/0210800 A1
(43) Pub. Date: Sep. 21, 2006

(54) Environmental barrier layer for silcon-containing substrate and process for preparing same

(76) Inventors: Irene Spitsberg, Loveland, OH (US); Christine Govern, Cincinnati, OH (US); Brian Thomas Hazel, West Chester, OH (US); Jennifer Su Saak, Maple Glen, PA (US); James Dale Steibel, Mason, OH (US)

Correspondence Address: JAGTIANI + GUTTAG, 10363-A DEMOCRACY LANE, FAIRFAX, VA, 22030, US

(21) Appl. No.: 11/084,104

(22) Filed: Mar. 21, 2005

(51) Int. Cl. B32B 9/00

(52) U.S. Cl. 428/408

(57) ABSTRACT

An article comprising a silicon carbide and/or silicon metal-containing substrate and an environmental barrier layer overlaying the substrate, wherein the environmental barrier layer has a thickness up to about 5 mils (127 microns) and comprises a reaction-generated corrosion resistant metal silicate. A process is also provided for reacting a metal source and a silica source over the silicon carbide and/or silicon metal-containing substrate to form the environmental barrier layer comprising the reaction-generated corrosion resistant metal silicate.

### STATEMENT REGARDING FEDERALLY SPONSORED RESEARCH

This invention was made with Government support under Contract No. N00019-96-C-0176 awarded by the JSF Program Office. The Government may have certain rights to the invention.

### BACKGROUND OF THE INVENTION

This invention broadly relates to a relatively thin environmental barrier layer comprising a reaction-generated corrosion resistant metal silicate and overlaying a silicon carbide and/or silicon metal alloy-containing substrate. This invention further broadly relates to a process for reacting a metal source and a silica source over the silicon carbide and/or silicon metal alloy-containing substrate to form a relatively thin environmental barrier layer comprising the reaction-generated corrosion resistant metal silicate.

Higher operating temperatures for gas turbine engines are continuously sought in order to improve their efficiency. Ceramic materials containing silicon, such as those comprising silicon carbide (SiC) as a matrix material and/or as a reinforcing material (e.g., as fibers) are currently being used for high temperature applications, such as gas turbine engines, heat exchangers, internal combustion engines, etc. These silicon-containing matrix/reinforcing materials are commonly referred to as ceramic matrix composites (CMCs). With regard to gas turbine engines, CMCs have been used in various turbine components, including combustors, airfoils, etc. However, as operating temperatures increase, the high temperature durability of such CMC materials must also correspondingly increase.

In normal gas turbine engine operating environments, substrates comprising these silicon-containing CMCs can recede and lose mass when exposed to high temperature, aqueous environments. For example, when exposed to a lean combustion environment of approximately 1atmosphere pressure of water vapor at 120020 C., silicon carbide can exhibit weight loss and recession at a rate of approximately 6 mils (152 microns) per 1000 hrs. This weight loss and recession is believed to involve volatilization of the protective silica scale (formed by oxidation of the silicon carbide surface) by reaction with water vapor, as represented by the following equation:
SiO₂+2H₂O═Si(OH)₄

The silica scale formed on the CMC substrate can provide an excellent diffusion barrier to prevent further diffusion of oxygen. Indeed, in some coating systems utilized to protect the underlying silicon carbide in the CMC substrate, this silica scale can be formed deliberately as a protective layer by preoxidation of the substrate. However, as described above, this silica scale can deteriorate in the presence of water or water vapor such as steam to form volatile silicon species such as Si(OH)₄. It is the loss of these volatile silicon species that cause recession and mass loss of the CMC substrate.

Various environmental barrier coating (EBC) systems have been suggested for protecting silicon-containing CMCs from oxidation at high temperatures and degradation in the presence of aqueous environments. These include EBCs comprising mullites (3Al₂O₃.2SiO₂) disclosed in, for example, commonly-assigned U.S. Pat. No. 6,129,954 (Spitsberg et al), issued Oct. 10, 2000, and U.S. Pat. No. 5,869,146 (McCluskey et al), issued Feb. 9, 1999. However, mullite does not provide adequate protection in high aqueous temperature environments because mullite has, thermodynamically, significant silica activity due to the high concentration of SiO₂ in mullite that volatilizes at high-temperatures in the presence of water or water vapor.

Other EBC systems suggested for protecting silicon-containing CMCs include those comprising barium strontium aluminosilicate (BSAS), with or without mullite, and with or without additional thermal barrier coatings such as those disclosed in, for example, commonly-assigned U.S. Pat. No. 5,985,470 (Spitsberg et al), issued Nov. 16, 1999; U.S. Pat. No. 6,444,335 (Wang et al), issued Sep. 3, 2002; and U.S. Pat. No. 6,607,852 (Spitsberg et al), issued Aug. 19, 2003; and U.S. Pat. No. 6,410,148 (Eaton et al), issued Jun. 25, 2002. These EBCs comprising BSAS are typically applied to the silicon-containing CMC substrates by thermal spraying techniques such as plasma spraying. Plasma spraying tends to form relatively thick coatings or layers that may not be suitable for certain applications. In addition, these EBCs comprising BSAS may not be sufficiently resistant to other forms of environmental attack.

Accordingly, it would be desirable to be able to provide an environmental barrier coating for silicon-containing CMC substrates that: (a) can be formed to provide coating thicknesses that are thinner than those provided by thermal spray techniques such as plasma spray; and (b) are resistant to environmental attack by other types of environmental contaminant compositions and corrosive agents.

### BRIEF DESCRIPTION OF THE INVENTION

An embodiment of this invention is broadly directed at an article comprising:
a silicon carbide and/or silicon metal alloy-containing substrate; and
an environmental barrier layer overlaying the substrate,
wherein the environmental barrier layer has a thickness up to about 5 mils (127 microns) and comprises a reaction-generated corrosion resistant metal silicate.

Another embodiment of this invention is broadly directed at a process comprising the following steps:
(a) providing a silicon carbide and/or silicon metal alloy-containing substrate; and
(b) reacting a metal source and a silica source to form over the substrate an environmental barrier layer comprising a reaction-generated corrosion resistant metal silicate, wherein the environmental barrier layer has a thickness up to about 5 mils (127 microns).

The article and method of this invention provide a number of advantages and benefits with regard to environmental barrier layers for silicon carbide and/or silicon metal alloy-containing substrates. The environmental barrier layers of this invention protect the underlying silicon carbide and/or silicon metal alloy-containing substrate from recession and loss caused by high temperature, aqueous environments. The environmental barrier layers of this invention also protect the underlying silicon carbide and/or silicon metal alloy-containing substrate from other environmental contaminant compositions and corrosive agents that can be formed from oxides of calcium, magnesium or mixtures thereof, as well as sulfates and/or chlorides of calcium, magnesium, sodium or mixtures thereof. The corrosion resistant metal silicates of this invention can be formed by the reaction of a metal source and silica source to provide environmental barrier layers having relatively thin thicknesses, i.e., up to about 5 mils (127 microns) that are more resistant to spallation. The environmental barrier layers of this invention can also be formed with corrosion resistant metal silicates that provide a better coefficient of thermal expansion (CTE) match with the underlying substrate, or optional silica scale layer overlaying the substrate, to impart additional spallation resistance.

### BRIEF DESCRIPTION OF THE DRAWINGS

FIG. 1 is a perspective view of a turbine blade for which the environmental barrier layer of this invention is useful.

FIG. 2 is an enlarged sectional view through the airfoil portion of the turbine blade of FIG. 1, taken along line 2-2, showing an embodiment of the environmental barrier layer of this invention overlaying the substrate of the airfoil portion.

### DETAILED DESCRIPTION OF THE INVENTION

As used herein, the term “environmental barrier layer” refers to environmental barrier layers of this invention that comprise a sufficient amount or level of corrosion resistant metal silicate generated by the reaction of a metal source and a silica source to provide a protective barrier for the underlying silicon carbide and/or silicon metal alloy-containing substrate, or optional silica scale layer, against various types of environmental attack, including those caused by high temperature, aqueous environments (e.g., steam), other environmental contaminant compositions and corrosive agents, for example those that are formed from oxides of calcium, magnesium, etc., or mixtures thereof, as well as sulfates and/or chlorides of calcium, magnesium, sodium, etc., or mixtures thereof, etc. These oxides, sulfates, and/or chlorides of calcium, magnesium, sodium, etc., or mixtures thereof can come from ingested sea salt or a contaminant composition comprising mixed calcium-magnesium-aluminum-silicon-oxide systems (Ca—Mg—Al—SiO), that are commonly referred to as “CMAS.” See, for example, U.S. Pat. No. 5,660,885 (Hasz et al), issued Aug. 26, 1997, which describes these CMAS environmental contaminant compositions. The environmental barrier layer can comprise at least about 90% corrosion resistant metal silicate, typically at least about 95% corrosion resistant metal silicate, and more typically 99% corrosion resistant metal silicate.

As used herein, the term “reaction-generated corrosion resistant metal silicate” refers to any metal silicate that can be formed by the reaction of a metal source and a silica source, and is resistant to environmental attack caused by high temperature, aqueous environments (e.g., steam), other environmental contaminant compositions and corrosive agents, for example those that are formed from oxides of calcium, magnesium, etc., or mixtures thereof (e.g., from CMAS), as well as sulfates and/or chlorides of calcium, magnesium, sodium, etc., or mixtures thereof (e.g., from sea salt), etc. Suitable corrosion resistant metal silicates that can be formed by reaction of a metal source and a silica source include yttrium silicates, scandium silicates, zirconium silicates, hafnium silicates, rare earth metal silicates such as lanthanum silicates, cerium silicates, praseodymium silicates, neodymium silicates, promethium silicates, samarium silicates, europium silicates, gadolinium silicates, terbium silicates, dysprosium silicates, holmium silicates, erbium silicates, thulium silicates, ytterbium silicates, lutetium silicates, etc., as well as various combinations of these metal silicates. The corrosion resistant metal silicate can be a monosilicate, a disilicate, an orthosilicate, a metasilicate, a polysilicate, etc., or combinations thereof. Typically, the corrosion resistant metal silicate is a yttrium silicate, a scandium silicate, a lutetium silicate, a ytterbium silicate, a zirconium silicate, a hafnium silicate, or a combination thereof, and more typically a yttrium silicate or a lutetium silicate. The corrosion resistant metal silicate of this invention is formed as a reaction product between a metal source (e.g., a metal oxide, metal nitrate, metal chloride, etc.) and a silica source that can come from, for example, the silicon carbide and/or silicon metal alloy-containing substrate, from a silica layer overlaying and typically adjacent to the substrate, for example, a silica scale layer that forms naturally from the substrate or that is formed intentionally or deliberately from the substrate, e.g., by preoxidizing a portion of the substrate to form a silica scale layer thereon, by depositing silicon on the substrate and then preoxidizing the deposited silicon to form a silica scale layer; by depositing silica on the substrate to form a silica scale layer, etc.

As used herein, the term “silicon carbide and/or silicon metal alloy-containing substrate” refers to a silicon-containing-substrate that comprises a silicon carbide, a silicon metal alloy (also referred to as a “metal silicide”), or combinations thereof. The substrate can comprise a substantially continuous matrix of silicon carbide and/or silicon metal alloy, can be a composite comprising a continuous matrix of silicon carbide and/or silicon metal alloy reinforced with discrete elements such as fibers, particles, etc. dispersed, embedded, etc., in the continuous matrix, etc. The discrete elements such as fibers, particles, etc., can be formed from silicon-containing ceramic materials, or can be formed from other materials, e.g., carbon fibers. Suitable silicon-containing ceramic materials for forming these discrete elements include silicon carbide, silicon carbide nitride, etc., or combinations thereof. Such combinations of dispersed, embedded, etc., fibers, particles, etc. in a continuous matrix of silicon carbide are typically referred to as ceramic matrix composites or CMCs. Typical CMCs comprise a continuous silicon carbide matrix that is fiber reinforced, usually with silicon-based fibers. These reinforcing fibers typically include a coating material that fully covers the fiber surfaces to impart and maintain structural integrity of the composite material systems. Typical fiber coating materials include boron nitride, silicon nitride, silicon carbide, carbon, etc. . Suitable silicon metal alloys useful as substrates include molybdenum-silicon alloys (molybdenum silicides), niobium-silicon alloys (niobium silicides), iron-silicon alloys (iron silicides), etc., or combinations thereof. Illustrative substrates suitable for suitable for use herein include a silicon carbide coated silicon carbide fiber-reinforced silicon carbide particles and a silicon metal alloy matrix, a carbon fiber-reinforced silicon carbide matrix, a silicon carbide fiber-reinforced silicon metal alloy matrix, etc.

As used herein, the term “thermal barrier coating” refers to those coatings that reduce heat flow to the underlying environmental barrier layer, silicon carbide and/or silicon metal alloy-containing substrate, optional silica scale layer, etc., of the article, i.e., form a thermal barrier, and which comprise ceramic materials have a melting point that is typically at least about 2600° F. (1426° C.), and more typically in the range of from about 3450° to about 4980° F. (from about 1900° to about 2750° C.). Suitable ceramic materials for thermal barrier coatings include, aluminum oxide (alumina), i.e., those compounds and compositions comprising Al₂O₃, including unhydrated and hydrated forms, various zirconias, in particular phase-stabilized zirconias (e.g., zirconia blended with various stabilizer metal oxides such as yttrium oxides), such as yttria-stabilized zirconias, ceria-stabilized zirconias, calcia-stabilized zirconias, scandia-stabilized zirconias, magnesia-stabilized zirconias, india-stabilized zirconias, ytterbia-stabilized zirconias, etc., as well as mixtures of such stabilized zirconias. See, for example, Kirk-Othmer's Encyclopedia of Chemical Technology, 3rd Ed., Vol. 24, pp. 882-883 (1984) for a description of suitable zirconias. Suitable yttria-stabilized zirconias can comprise from about 1 to about 20% yttria (based on the combined weight of yttria and zirconia), and more typically from about 3 to about 10% yttria. These phase-stabilized zirconias can further include one or more of a second metal (e.g., a lanthanide or actinide) oxide such as dysprosia, erbia, europia, gadolinia, neodymia, praseodymia, urania, and hafnia to further reduce thermal conductivity of the thermal barrier coating. See U.S. Pat. No. 6,025,078 (Rickerby et al), issued Feb. 15, 2000 and U.S. Pat. No. 6,333,118 (Alperine et al), issued Dec. 21, 2001, both of which are incorporated by reference. Suitable ceramic materials for thermal barrier coatings also include pyrochlores of general formula A₂B₂O₇ where A is a metal having a valence of 3+ or 2+ (e.g., gadolinium, aluminum, cerium, lanthanum or yttrium) and B is a metal having a valence of 4+ or 5+ (e.g., hafnium, titanium, cerium or zirconium) where the sum of the A and B valences is 7. Representative materials of this type include gadolinium-zirconate, lanthanum titanate, lanthanum zirconate, yttrium zirconate, lanthanum hafnate, cerium zirconate, aluminum cerate, cerium hafnate, aluminum hafnate and lanthanum cerate. See U.S. Pat. No. 6,117,560 (Maloney), issued Sep. 12, 2000; U.S. Pat. No. 6,177,200 (Maloney), issued Jan. 23, 2001; U.S. Pat. No. 6,284,323 (Maloney), issued Sep. 4, 2001; U.S. Pat. No. 6,319,614 (Beele), issued Nov. 20, 2001; and U.S. Pat. No. 6,387,526 (Beele), issued May 14, 2002, all of which are incorporated by reference.

As used herein, the term “comprising” means various compositions, compounds, components, coatings, substrates, layers, steps, etc., can be conjointly employed in this invention. Accordingly, the term “comprising” encompasses the more restrictive terms “consisting essentially of” and “consisting of.”

As used herein, the term “CTE” refers to the coefficient of thermal expansion of a material, and is typically defined in units of 10⁻⁶/°F. or 10^{-6/°C.}

All amounts, parts, ratios and percentages used herein are by weight unless otherwise specified.

This invention is based on the discovery that, while prior environmental barrier coating (EBC) systems can protect the underlying silicon carbide and/or silicon metal alloy-containing substrate of articles (e.g., gas turbine engine components) from certain types of environmental attack, primarily those such as recession caused high temperature aqueous environments (e.g., a hot steam environment), there are other environmental conditions that these prior EBC systems do not protect against or protect against poorly. For example, EBC systems comprising in whole or in part barium strontium aluminosilicate (BSAS), with or without mullite, can be vulnerable to these other forms of environmental attack. These other forms of environmental attack can be equally as detrimental as recession caused by hot aqueous (e.g., steam) environments. One such type of other environment attack is caused by environmental contaminant compositions and corrosive agents formed from oxides of calcium, magnesium, etc., or mixtures thereof, (e.g., from CMAS), as well as sulfates and/or chlorides of calcium, magnesium, sodium, etc., or mixtures thereof, (e.g., from sea salt.

At higher temperatures during engine operation, these other environmental contaminants such as CMAS can adhere to the hot EBC surface comprising BSAS, or in the case of sea salt, can be ingested into the engine with the air. It has been found that chemical and mechanical interactions can occur between these contaminant compositions and the BSAS in the EBC systems. In particular, these contaminant compositions have found to interact with the BSAS so as to chemically alter the EBC, thus forming amorphous or glassy phases in the EBC when exposed to water vapor and creating open porous channels through the modified EBC, such that the protective capabilities of the EBC are compromised.

This invention is based on the additional discovery that these EBCs should be formed on the underlying silicon carbide and/or silicon metal alloy-containing substrate to be relatively thin. For example, a turbine airfoil comprising a silicon carbide-containing CMC substrate can be coated with an EBC that is applied by plasma-spray techniques. However, plasma-spray application methods can be limited in how thin they can form the coating. These higher thickness coatings on thinner sections of the airfoil, such as the trailing edge, can create design limitations, as well as undesirably increasing the mass or weight of the airfoil. In particular, plasma-spray application methods do not provide easy control of the thickness distribution of the coating on shaped components such as airfoils where thickness tolerances can be relatively tight. Plasma-spray application methods can also impart relatively high roughness values to the resultant coating. This higher coating roughness requires thicker coatings to be deposited with this higher roughness being reduced by a post-coating operation such as polishing or tumbling, resulting into increased processing costs.

In addition, certain materials such as rare earth silicates that can be used as corrosion resistant barrier layers in EBCs can have CTEs that are significantly different from that of the underlying silicon carbide and/or silicon metal alloy-containing substrate, or optional silica scale layer overlaying the substrate. When materials having such CTE differences are plasma sprayed to form thicker layers on the silicon carbide and/or silicon metal alloy-containing substrate, or a silica scale layer overlaying the substrate, these thicker plasma-sprayed layers can be more prone to spalling when subjected to thermal shock/thermal gradient conditions. To overcome this tendency of thicker plasma-sprayed layers to spall, the inclusion of additional bond coat layers to enhance adhesion can be required, thus increasing the thickness of the EBC.

The environmental barrier layers of this invention solve these problems by forming a relatively thin layer comprising a corrosion resistant metal silicate that is generated by the reaction of a metal source and silica source over the silicon carbide and/or silicon metal alloy-containing substrate, or optionally a silica scale layer overlaying the substrate. The environmental barrier layer comprising these reaction-generated corrosion resistant metal silicates protect the underlying silicon carbide/silicon-containing substrate (and any optional silicon scale layer) from recession and loss caused by high temperature, aqueous environments such as steam. In addition, and unlike prior EBC systems such as those comprising BSAS, the environmental barrier layers of this invention are also resistant to other environmental attacks, such as those caused by environmental contaminant compositions and corrosive agents formed from oxides of calcium, magnesium, etc., and mixtures thereof (e.g., from CMAS), as well as sulfates and/or chlorides of calcium, magnesium, sodium, etc., or mixtures thereof (e.g., from sea salt).

The corrosion resistant metal silicates comprising these environmental barrier layers can also be formed by processes and techniques involving the reaction of a metal source and a silica source to provide relatively thin layers, e.g., as thin as about 0.5 mils (13 microns) and up to about 5 mils (127 microns) in thickness. Because of these relatively thin thicknesses, the environmental barrier layers of this invention have a reduced tendency to spall off when there is a significant difference in CTE between the corrosion resistant metal silicate and the underlying silicon carbide and/or silicon metal alloy-containing substrate, or optional silica scale layer. In addition to reducing the layer thickness, certain corrosion resistant metal silicates such as yttrium silicates and lutetium silicates can be generated to form environmental barrier layers that are not significantly different in CTE from the underlying silicon carbide and/or silicon metal alloy-containing substrate (or optional silica scale layer) so that the environmental barrier layer is more adherent to the underlying substrate/silica scale layer, and thus even less prone to spallation.

The environmental barrier layer of this invention is useful with silicon carbide and/or silicon metal alloy-containing substrates used in a wide variety of turbine engine (e.g., gas turbine engine) parts and components operated at, or exposed to, high temperatures, especially higher temperatures that occur during normal engine operation. These turbine engine parts and components can include turbine airfoils such as turbine blades and vanes, turbine shrouds, turbine nozzles, combustor components such as liners, deflectors and their respective dome assemblies, augmentor hardware of gas turbine engines, etc. The environmental barrier layer of this invention is particularly useful for articles comprising silicon carbide and/or silicon metal-containing substrates in the form of turbine blades and vanes, and especially the airfoil portions of such blades and vanes. However, while the following discussion of articles of this invention will be with reference to turbine blades and vanes, and especially the airfoil portions thereof, that comprise these blades and vanes, it should also be understood that the environmental barrier layer of this invention can be useful with other articles comprising silicon carbide and/or silicon metal-containing substrates that require environmental barrier protection.

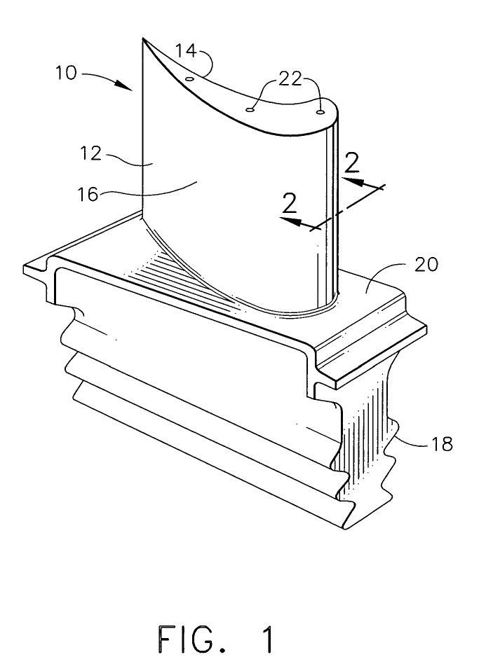

The various embodiments of this invention are further illustrated by reference to the drawings as described hereafter. Referring to the drawings, FIG. 1 depicts a component article of a gas turbine engine such as a turbine blade or turbine vane, and in particular a turbine blade identified generally as 10. (Turbine vanes have a similar appearance with respect to the pertinent portions.) Blade 10 generally includes an airfoil 12 against which hot combustion gases are directed during operation of the gas turbine engine, and whose surfaces are therefore subjected to severe attack by high temperature aqueous environments (e.g., steam), as well as other environmental contaminants such as CMAS or sea salt. Airfoil 12 has a “high-pressure side” indicated as 14 that is concavely shaped; and a suction side indicated as 16 that is convexly shaped and is sometimes known as the “low-pressure side” or “back side.” In operation the hot combustion gas is directed against the high-pressure side 14. Blade 10 is anchored to a turbine disk (not shown) with a dovetail 18 formed on the root section 20 of blade 10. In some embodiments of blade 10, a number of internal passages extend through the interior of airfoil 12, ending in openings indicated as 22 in the surface of airfoil 12. During operation, a flow of cooling air is directed through the internal passages (not shown) to cool or reduce the temperature of airfoil 12.

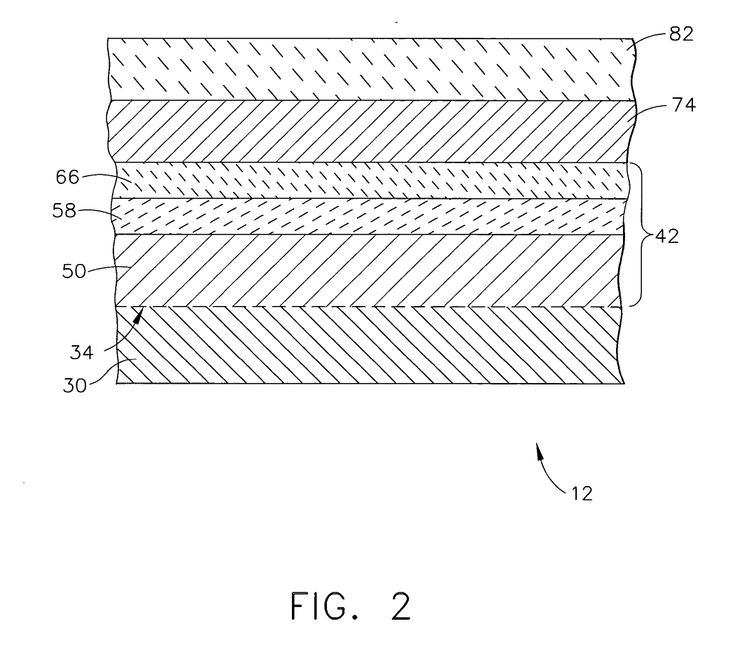

Referring to FIG. 2, the base material of airfoil 12 of blade 10 comprising the silicon carbide and/or silicon metal-containing substrate is indicated generally as 30. Surface 34 of substrate 30 can be pretreated to remove substrate fabrication contamination (e.g., cleaning surface 34) to improve adherence thereto, to provide a silica scale on surface 34, etc. For example, substrate 30 can be pretreated by subjecting surface 34 to a grit blasting step. This grit blasting step is typically carried out carefully in order to avoid damage to surface 34 of substrate 30 such as silicon carbide fiber reinforced CMC substrate. The particles used for the grit blasting should also be hard enough to remove the undesired contamination but not so hard as to cause significant erosive removal of substrate 30. The abrasive particles typically used in grit blasting are sufficiently small to prevent significant impact damage to surface 34 of substrate 30. When processing a substrate 30, for example, silicon carbide CMC substrate, grit blasting is typically carried out with alumina particles, typically having a particle size of about 0.30 microns or less, and typically at a velocity of from about 150 to about 200 m/sec.

With or without grit blasting, it can also be useful to form a layer containing silicon and oxygen (and optionally other trace elements, including those that can be present in the environmental barrier layer) such as a silica scale layer indicated generally as 50 on surface 34 of substrate 30 prior to forming the environmental barrier layer to improve the adherence thereof and to provide a silica source useful in forming the corrosion resistant metal silicate that the environmental barrier layer comprises. This silica source can become more desirable as the environment barrier coating thickness increases, i.e., to greater than about 0.5 mils (13 microns). This silica scale layer 50 can be formed by depositing a silica scale layer, preoxidizing substrate 30 to form silica scale layer 50, etc. When formed by preoxidizing substrate 30, this silica scale layer 50 typically has a thickness of from about 0.1 to about 50 microns, more typically a thickness of from about 2 to about 20 microns. This silica scale layer 50 is typical form by preoxidation of substrate 30, for example, by subjecting substrate 30 to a temperature of from about 800° to about 1200° C. for from about 15 minutes to about 100 hours.

As shown in FIG. 2, adjacent to and overlaying silica scale layer 50 (or surface 34 of substrate 30 in the absence of silica scale layer 50) is the environmental barrier layer (EBL) of this invention indicated generally as 58. EBL 58 is prepared by reacting a metal source (e.g., a metal oxide such as yttria, a metal nitrate, a metal halide, such as a metal chloride, metal fluoride, metal bromide, etc.) with a silica source that can come from, for example, substrate 30, from silica scale layer 50 overlaying and adjacent to 30 substrate, etc. The reaction between the metal source and the silica source is typically carried out under conditions that allow for the formation of an EBL 58 that is relatively thin, i.e., up to a thickness of about 5 mils (127 microns). Typically, EBL 58 is formed to have a thickness of from about 0.5 to about 5 mils (from about 13 to about 127 microns), more typically from about 1 to about 2.5 mils (from about 25 to about 64 microns). EBL 58 can be formed on silica scale layer 50 (or on surface 34 of substrate 30 in the absence of silica scale layer 50) as a relatively thin layer by processes or techniques similar to those used to prepare diffusion coatings (e.g., aluminide diffusion coatings), including chemical vapor deposition (CVD) techniques, pack cementation techniques, etc, know those skilled in the art. Typically, relatively thin EBL layers 58 are formed by the reaction of a metal oxide (e.g., yttria) with silica scale layer 50.

As also shown in FIG. 2, an optional thermal barrier coating (TBC) indicated generally as 66 can be formed on or over EBL 58, with or without an additional transition layer therebetween for CTE compatibility. This TBC 66 typically has a thickness of from about 1 to about 30 mils (from about 25 to about 769 microns), more typically from about 3 to about 20 mils (from about 75 to about 513 microns). TBC 66 can be formed on EBL 58 by variety of techniques. For example, TBC 66 can be formed on EBL 58 by physical vapor deposition (PVD), such as electron beam PVD (EB-PVD), filtered arc deposition, or by sputtering. Suitable sputtering techniques for use herein include but are not limited to direct current diode sputtering, radio frequency sputtering, ion beam sputtering, reactive sputtering, magnetron sputtering and steered arc sputtering. PVD techniques can form TBCs 66 having strain resistant or tolerant microstructures such as vertical microcracked structures. EB-PVD techniques can form columnar structures that are highly strain resistant to further increase the coating adherence. See, for example, U.S. Pat. No. 5,645,893 (Rickerby et al), issued Jul. 8, 1997 (especially col. 3, lines 36-63) and U.S. Pat. No. 5,716,720 (Murphy), issued Feb. 10, 1998) (especially col. 5, lines 24-61) (all of which are incorporated by reference), which disclose various apparatus and methods for applying TBCs by PVD techniques, including EB-PVD techniques.

An alternative technique for forming TBCs 66 is by thermal spray. As used herein, the term “thermal spray” refers to any method for spraying, applying or otherwise depositing TBC 66 that involves heating and typically at least partial or complete thermal melting of the ceramic material and depositing of the heated/melted ceramic material, typically by entrainment in a heated gas stream, onto EBL 58. Suitable thermal spray deposition techniques include plasma spray, such as air plasma spray (APS) and vacuum plasma spray (VPS), high velocity oxy-fuel (HVOF) spray, detonation spray, wire spray, etc., as well as combinations of these techniques. A particularly suitable thermal spray deposition technique for use herein is plasma spray. Suitable plasma spray techniques are well known to those skilled in the art. See, for example, Kirk-Othmer Encyclopedia of Chemical Technology, 3rd Ed., Vol. 15, page 255, and references noted therein, as well as U.S. Pat. No. 5,332,598 (Kawasaki et al), issued Jul. 26, 1994; U.S. Pat. No. 5,047,612 (Savkar et al) issued Sep. 10, 1991; and U.S. Pat. No. 4,741,286 (Itoh et al), issued May 3, 1998 (herein incorporated by reference) which describe various aspects of plasma spraying suitable for use herein, including apparatus for carrying out plasma spraying.

While specific embodiments of the this invention have been described, it will be apparent to those skilled in the art that various modifications thereto can be made without departing from the spirit and scope of this invention as defined in the appended claims.

What is claimed is:

1. An article comprising:
a silicon carbide and/or silicon metal-containing substrate; and
an environmental barrier layer overlaying the substrate,
wherein the environmental barrier layer has a thickness up to about 5 mils and comprises a reaction-generated corrosion resistant metal silicate.

2. The article of claim 1 wherein the environmental barrier layer has a thickness of from about 0.5 to about 5 mils.

3. The article of claim 2 wherein the environmental barrier layer has a thickness of from about 1 to about 2.5 mils.

4. The article of claim 2 which comprises a turbine airfoil.

5. The article of claim 4 which is a turbine blade.

6. The article of claim 1 wherein the substrate comprises a silicon metal alloy.

7. The article of claim 6 wherein the silicon metal alloy is a silicon-molybdenum alloy, a silicon-niobium alloy, a silicon-iron alloy or a combination thereof.

8. The article of claim 1 wherein the substrate comprises silicon carbide or a continuous matrix of silicon carbide reinforced with discrete elements.

9. The article of claim 8 wherein the substrate comprises a continuous matrix of silicon carbide reinforced with discrete elements and wherein the discrete elements are silicon carbide fibers or carbon fibers.

10. The article of claim 1 wherein the environmental barrier layer comprises at least about 90% corrosion resistant metal silicate.

11. The article of claim 10 wherein the environmental barrier layer comprises at least about 99% corrosion resistant metal silicate.

12. The article of claim 10 wherein the corrosion resistant metal silicate comprises a yttrium silicate, a scandium silicate, a zirconium silicate, a hafnium silicate, a rare earth metal silicate, or a combination thereof.

13. The article of claim 12 wherein the corrosion resistant metal silicate comprises a yttrium silicate, a scandium a silicate, a lutetium silicate, a ytterbium silicate, a zirconium silicate, a hafnium silicate, or a combination thereof.

14. The article of claim 13 wherein the corrosion resistant metal silicate comprises yttrium silicate or lutetium silicate.

15. The article of claim 1 which further comprises a silica scale layer adjacent to and overlaying the substrate, wherein the environmental barrier layer is adjacent to and overlaying the silica scale layer, and wherein the corrosion resistant metal silicate is formed by reaction of a metal source with the silica scale layer.

16. The article of claim 15 wherein the silica scale layer is formed by preoxidizing a portion of the substrate and has a thickness of from about 0.5 to about 50 microns.

17. The article of claim 1 which further comprises a thermal barrier coating overlaying the environmental barrier layer.

18. A process comprising the following steps:
(a) providing a silicon carbide and/or silicon metal-containing substrate; and
(b) reacting a metal source and a silica source to form over the substrate an environmental barrier layer comprising a reaction-generated corrosion resistant metal silicate, wherein the environmental barrier layer has thickness up to about 5 mils.

19. The process of claim 18 which comprises the further step of subjecting the surface of the substrate to grit blasting prior to step (b).

20. The process of claim 18 which comprises the further step of forming a silica scale layer on the surface of the substrate prior to step (b).

21. The process of claim 20 wherein the silica scale layer is formed by preoxidizing a portion of the substrate.

22. The process of claim 20 wherein step (b) is carried out by reacting the metal source with the silica scale layer.

23. The process of claim 18 wherein the substrate has an adjacent and overlaying silica scale layer prior to step (b) and wherein step (b) is carried out by reacting the metal source with the silica scale layer.

24. The process of claim 23 wherein the metal source is a metal oxide.

25. The process of claim 24 wherein the metal oxide is yttria.
